(19) United States
(12) Patent Application Publication
(10) Pub. No.: US 2026/0054622 A1
(43) Pub. Date: Feb. 26, 2026

(54) SEAT

(71) Applicant: DELTA KOGYO CO., LTD., Hiroshima (JP)

(72) Inventor: Takahiro OKUI, Hiroshima (JP)

(73) Assignee: DELTA KOGYO CO., LTD., Hiroshima (JP)

(21) Appl. No.: 19/103,770

(22) PCT Filed: Aug. 31, 2023
(86) PCT No.: PCT/JP2023/031829

§ 371 Date: Feb. 13, 2025

(30) Foreign Application Priority Data
Oct. 5, 2022 (JP) 2022-160948

(51) Int. Cl. B60N 2/58

(52) U.S. Cl. CPC B60N 2/5883

(57) ABSTRACT

A seat includes a recess having an inner bottom surface and an inner side surface defined by a trim. The trim is formed of a single member three-dimensionally sewn, and has a bottom part that defines the inner bottom surface of the recess and a side part that defines the inner side surface of the recess, the bottom part and the side part being continuous to each other.

### TECHNICAL FIELD

The present invention relates to a seat.

### BACKGROUND ART

A seat such as a vehicle seat may include a recess in a seat cushion, in a seatback, in an armrest, or in other part of the seat. The recess in the seat has an inner bottom surface and an inner side surface defined by a part of a trim cover (hereinafter, refer to as “trim”.) (see Patent Literature 1).

A configuration of such a trim defining an inner bottom surface and an inner side surface of a recess in a seat according to a prior art will be described with reference to FIG. 13.

As illustrated in FIG. 13, in the seat according to the prior art, a trim having three trim pieces 901 to 903 that are three-dimensionally sewn is arranged to define the inner bottom surface and the inner side surface of the recess. The configuration of the trim illustrated in FIG. 13 is applicable to a belt buckle container (a recess to accommodate a buckle of a seatbelt) provided in a seat cushion at a rear seat of a vehicle.

Specifically, the trim piece 901 constitutes a bottom part that defines the inner bottom surface of the belt buckle container (recess), and the trim piece 902 and the trim piece 903 constitute a side part that defines an inner side surface of the recess. The trim piece 903 is bent into a U-shape along two creases LN91, LN92, and has an end 903a to be sewn to an end 901a of the trim piece 901 (arrow C1), an end 903b to be sewn to an end 901b of the trim piece 901 (arrow C2), and an end 903c to be sewn to an end 901c of the trim piece 901 (arrow C3). The trim piece 902 has an end 902b to be sewn to an end 903d of the trim piece 903 (arrow C4), and an end 902c to be sewn to an end 903e of the trim piece 903 (arrow C5). The end 902a of the trim piece 902 and the end 901d of the trim piece 901 are not sewn together to define a belt insertion opening therebetween and allow a seatbelt to be inserted through the opening.

Besides, a resin plate member 912 is arranged on a back surface (that is closer to a cushion pad) of the bottom part constituted by the trim piece 901. The resin plate member 912 is sewn to the trim piece 901 and the trim piece 903 along sewing lines LN93 to LN95 (arrow C6). The resin plate member 912 is attached to the trim to keep the bottom part of the trim piece 901 flat and prevent the bottom part or other part from wrinkling.

However, the seat according to the prior art in which the trim is formed of the plurality of trim pieces 901 to 903 three-dimensionally sewn is considered to have disadvantages attributed to an increase in a manufacturing cost and a poor appearance quality. Specifically, the trim pieces 901 to 903 are required to be sewn together for the seat according to the prior art. A work of such sewing is complicated. Further, elaborate management is required to manage members for the trim pieces 901 to 903. The complicated work and elaborate management may lead to the increase in the manufacturing cost.

Moreover, the trim pieces 901 to 903 are three-dimensionally sewn together to form the trim having a three-dimensional shape in the seat according to the prior art. This may cause a dimensional difference among the trim pieces 901 to 903 at cutting of the trim pieces, or another difference at sewing of the trim pieces. Such a difference may result in the disadvantage attributed to the poor appearance quality.

Although a vehicle seat is exemplified as a seat above, another seat except the vehicle seat may have the disadvantages described above.

### CITATION LIST

### Patent Literature

Patent Literature 1: Japanese Unexamined Patent Publication No. 2021-160505

### SUMMARY OF INVENTION

The present invention has been accomplished to overcome the disadvantages described above. The present invention has an object of providing a seat that includes a recess having an inner bottom surface and an inner side surface defined by a trim, and further avoids an increase in a manufacturing cost and attains a superior appearance quality.

A seat according to one aspect of the present invention includes a recess having an inner bottom surface and inner side surface defined by a trim. The trim is formed of a single member three-dimensionally sewn, and has: a bottom part that defines the inner bottom surface of the recess; and a side part that defines the inner side surface of the recess, the bottom part and the side part being continuous to each other.

### BRIEF DESCRIPTION OF DRAWINGS

FIG. 1 is a perspective view of a configuration of a vehicle rear seat according to an embodiment.

FIG. 2 is a perspective view of a belt buckle container and a periphery therereound seen from obliquely above.

FIG. 3 is a cross-sectional view taken along the line III-III in FIG. 2

FIG. 4 is a cross-sectional view of a configuration around a belt insertion opening.

FIG. 5 is a development view of a configuration of a recess trim.

FIG. 6A is a plan view of a resin plate member included in the vehicle rear seat according to the embodiment.

FIG. 6B is a plan view of a resin plate member included in a vehicle rear seat according to a prior art.

FIG. 7 is a perspective view of a bottom part and a rear side part in a configuration of a belt buckle container in a vehicle rear seat according to a first modification.

FIG. 8 is a development view of a configuration of a recess trim in a vehicle rear seat according to a second modification.

FIG. 9 is a development view of a configuration of a recess trim in a vehicle rear seat according to a third modification.

FIG. 10 is a development view of a configuration of a recess trim in a vehicle rear seat according to a fourth modification.

FIG. 11 is a development view of a configuration of a recess trim in a vehicle rear seat according to a fifth modification.

FIG. 12 is a development view of a configuration of a recess trim in a vehicle rear seat according to a sixth modification.

FIG. 13 is a development view for explaining a configuration of a recess in the vehicle rear seat according to the prior art.

### DESCRIPTION OF EMBODIMENTS

Hereinafter, an embodiment of the present invention will be described with reference to the accompanying drawings. It should be noted that the following embodiment illustrates one specific example of the present invention, and the present invention is not limited to the embodiment except its essential configuration.

Moreover, in each drawing to be referred to in the following description, the sign “FR” denotes a front direction or front of a vehicle, the sign “RR” denotes a rear direction or rear of the vehicle, the sign “LH” denotes a left direction or left of the vehicle, the sign “RH” denotes a right direction or right of the vehicle, the sign “UP” denotes an upper direction or upper position of the vehicle, and the sign “LO” denotes a lower direction or lower position of the vehicle.

### Embodiment

### 1. Configuration of a Vehicle Rear Seat 1

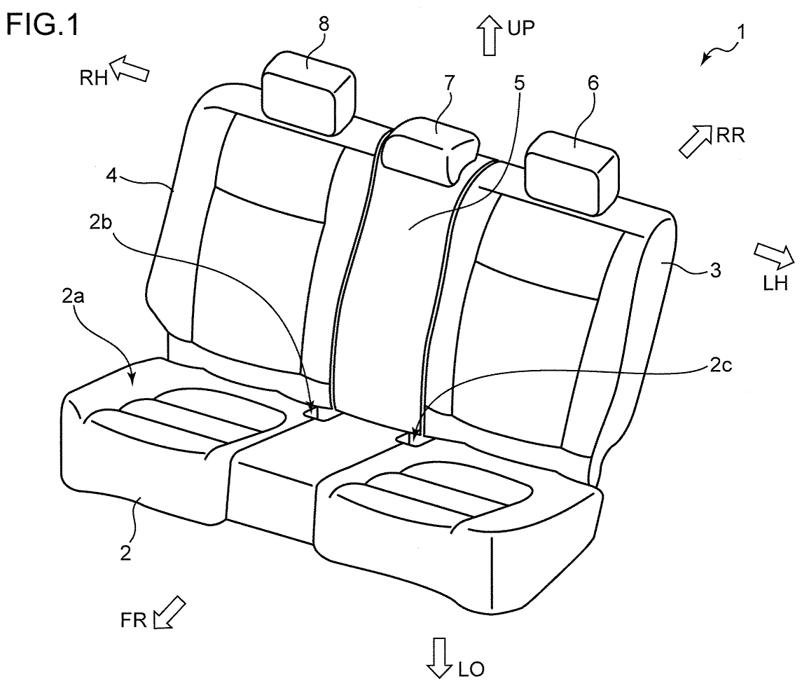

The configuration of the vehicle rear seat 1 according to the embodiment will be described with reference to FIG. 1. The vehicle rear seat 1 according to the embodiment is an example seat according to the present invention.

As illustrated in FIG. 1, the vehicle rear seat 1 according to the embodiment is a seat for three occupants in a vehicular width direction. The vehicle rear seat 1 includes a seat cushion 2, seatbacks 3 to 5, and headrests 6 to 8. Each of the seatbacks 3 to 5 is configured to be tiltable forward.

The seat cushion 2 has a sitting part 2a and belt buckle containers (recesses) 2b, 2c each recessed downward from the sitting part 2a. Each of the belt buckle containers 2b, 2c is configured to accommodate a buckle of a seatbelt when no occupant is seated on the sitting part 2a.

### 2. Configuration of Each of the Belt Buckle Containers 2b, 2c

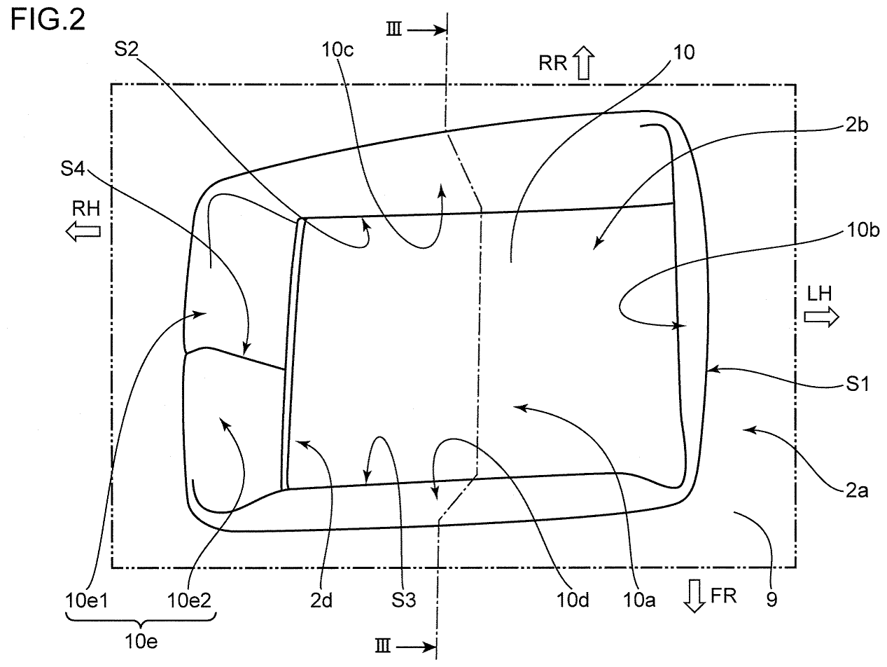

The configuration of each of the belt buckle containers 2b, 2c provided in the seat cushion 2 of the vehicle rear seat 1 will be described with reference to FIG. 2 to FIG. 4. Although only the configuration of the belt buckle container 2b will be described as an example below, it is noted that the belt buckle container 2c has the same configuration.

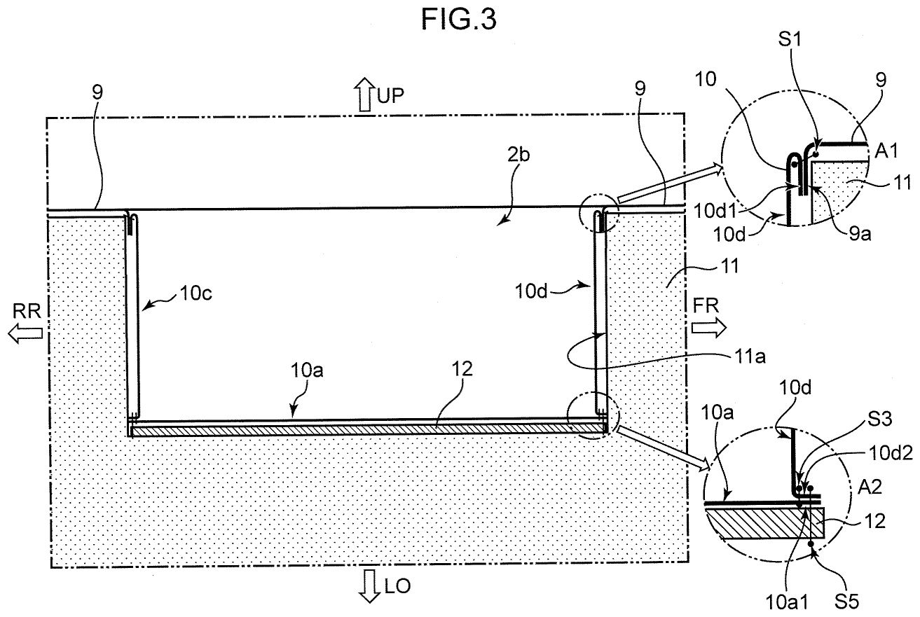

As illustrated in FIG. 2, the belt buckle container 2b has a rectangular open space in a plan view from the upper position. As illustrated in FIG. 2 and FIG. 3, the belt buckle container 2b includes: a recess trim (hereinafter, simply referred to as a “trim”) 10 that defines an entire inner surface including an inner bottom surface and an inner side surface of the belt buckle container 2b; and a resin plate member (reinforcement plate member) 12 located between the trim 10 and the cushion pad 11 at the inner bottom surface of the belt buckle container 2b. The reinforcement plate member 12 is made of, for example, polypropylene (PP).

As illustrated in FIG. 2, the trim 10 has a bottom part 10a and side parts 10b to 10e. In the vehicle rear seat 1 according to the embodiment, the trim 10 is formed of a single continuous member, and the bottom part 10a and the left side part 10b are continuous to each other. This structure will be described later.

Each of the side parts 10b to 10e has a rim at a top thereof (a rim at a closer position on a paper of FIG. 2) sewn to a sitting base trim 9 around the belt buckle container 2b at the sitting part 2a (along a seam S1). The top of each of the side parts 10b to 10e is sewn to the sitting base trim 9 over an entire circumference defining the open space of the belt buckle container 2b.

In the trim 10, an end of the bottom part 10a and an end of the rear side part 10c are sewn together (along a seam S2). Similarly, an end of the bottom part 10a and an end of the front side part 10d are sewn together (along a seam S3).

An end of the bottom part 10a and an end of the right side part 10e are not sewn together to define an opening therebetween. The opening serves as a belt insertion opening 2d allowing a belt to be inserted therethrough and connected to the belt buckle. The right side part 10e includes a rear right side part 10e1 and a front right side part 10e2 respectively having ends sewn together around a central position in the vehicular width direction (along a seam S4). The seam S4 extends from the top to the bottom of the belt buckle container 2b in a depth direction thereof (an up-down direction of the vehicle).

As illustrated in an area A1 in FIG. 3, a seam allowance 10d1 of the front side part 10d of the trim 10 and a seam allowance 9a of the sitting base trim 9 are sewn together along the seam S1.

As illustrated in an area A2 in FIG. 3, a seam allowance 10d2 of the front side part 10d and a seam allowance 10a1 of the bottom part 10a are sewn together along the seam S3. The seam allowance 10d2 of the front side part 10d and the seam allowance 10a1 of the bottom part 10a are further sewn to the resin plate member 12 located under the bottom part 10a along the seam S5.

FIG. 3 illustrates an excerpted sewn portion of the sitting base trim 9 and the trim 10, and a specific sewn portion of the bottom part 10a of the trim 10 and each of the side parts 10b to 10c. It is noted here that other sewn portion has a similar or same configuration in the embodiment.

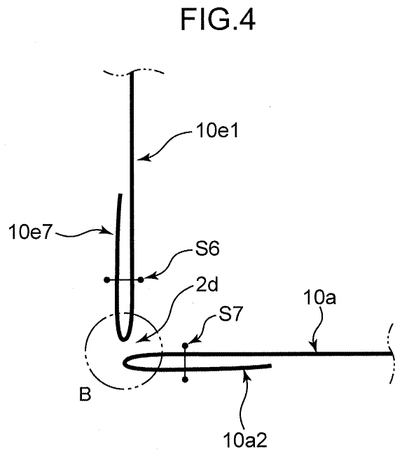

As illustrated in FIG. 4, an end section (folded-back section 10e7) of the rear right side part 10e1 and an end section (folded-back section 10a2) of the bottom part 10a are folded back around the belt insertion opening 2d (in an area B), the folded-back sections being sewn at overlapping portions respectively in the rear right side part (along the seam S6) and the bottom part (along the seam S7).

Although FIG. 4 omits illustration, the front right side part 10e2 has a section facing the belt insertion opening 2d and folded back therefrom in the same manner as the rear right side part 10e1 and the folded-back section is sewn at an overlapping portion in the front right side part.

### 3. Configuration of the Trim 10 Yet to be Three-Dimensionally Sewn

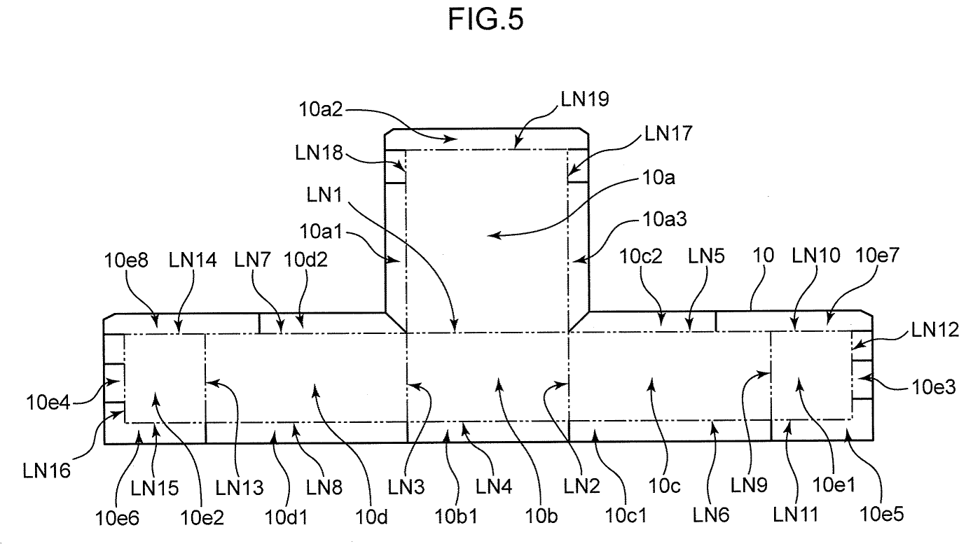

The configuration of the trim 10 yet to be three-dimensionally sewn will be described with reference to FIG. 5. FIG. 5 is a development view of a member having been cut to form the trim 10.

As illustrated in FIG. 5, the trim 10 has parts 10a to 10d, 10e1, and 10e2 being continuous and each having a rectangular shape. The side parts 10b to 10d, 10e1, and 10e2 are continuous to have a long strip shape as a whole. The bottom part 10a is continuous to the left side part 10b across a line LN1 and extends in a direction perpendicularly intersecting a longitudinal direction of the side parts 10b to 10d, 10e1, and 10e2.

The trim 10 has sections to be folded-back, i.e., folded-back sections 10a2, 10e7, and 10e8, and seam allowances 10a1, 10a3, 10b1, 10c1, 10c2, 10d1, 10d2, and 10e3 to 10e6, the sections and seam allowances serving as associated ends of the parts 10a to 10d, 10e1, and 10e2. The folded-back sections 10a2, 10e7, and 10e8, and the seam allowances 10a1, 10a3, 10b1, 10c1, 10c2, 10d1, 10d2, and 10e3 to 10e6 are continuous to the parts 10a to 10d, 10e1, and 10e2 across associated lines LN4 to LN8, LN10 to LN12, and LN14 to LN19. The folded-back sections 10a2, 10e7, and 10e are folded back respectively on the creases LN19, LN10, and LN14, and sewn at overlapping portions respectively.

In three-dimensionally sewing the trim 10 illustrated in FIG. 5, the trim 10 is bent on the lines LN1 to LN3, LN9, and LN13, and sewn along meeting lines among the sewing lines LN5, LN7, LN12, LN16, LN17, and LN18. Specifically, the trim 10 is sewn along the sewing line LN5 and the sewing line LN17 meeting each other, and sewn along the sewing line LN7 and the sewing line LN18 meeting each other. The trim is further sewn along the sewing line LN12 and the sewing line LN16 meeting each other. Besides, the trim is sewn to ends (seam allowances) of the sitting base trim 9 along the sewing lines LN4, LN6, LN8, LN11, and LN15.

### 4. Sewing of the Resin Plate Member 12 to the Bottom Part 10a of the Trim 10

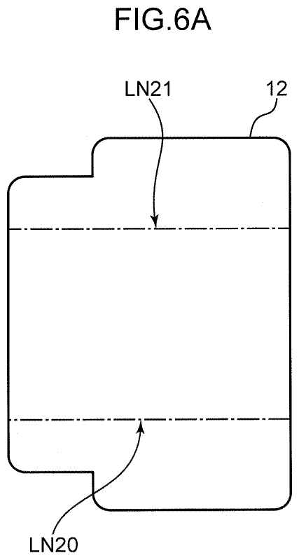

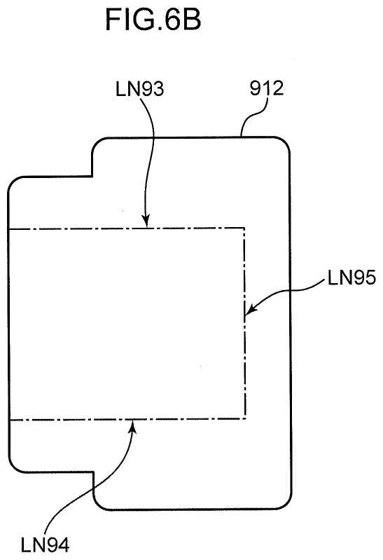

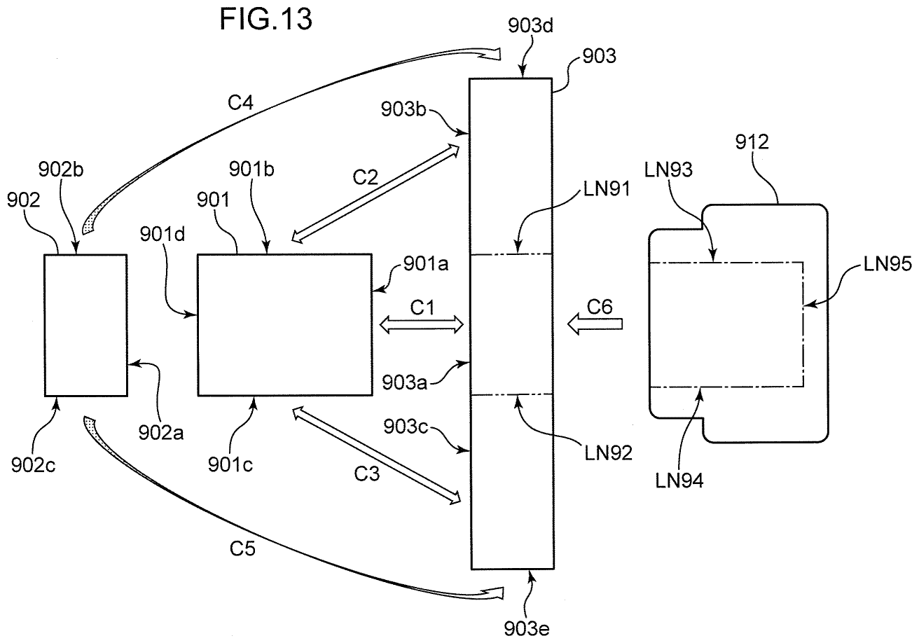

The sewing of the resin plate member 12 to the bottom part 10a of the trim 10 will be described with reference to FIG. 6A and FIG. 6B. FIG. 6A illustrates the resin plate member 12 included in the vehicle rear seat 1 according to the embodiment. FIG. 6B illustrates the resin plate member 912 included in the seat according to the prior art described with reference to FIG. 13 as a comparative example.

As illustrated in FIG. 6B, concerning the seat according to the prior art, the resin plate member 912 is required to be sewn to the trim pieces 901, 903 (see FIG. 13) along the sewing lines LN93 to LN95. Specifically, to three-dimensionally sew the three trim pieces 901 to 903, the prior art requires sewing of the end 901a of the trim piece 901 to the end 903a of the trim piece 903 (see FIG. 13) along the sewing line LN95, sewing of the end 901b of the trim piece 901 to the end 903b of the trim piece 903 (see FIG. 13) along the sewing line LN93, and sewing of the end 901c of the trim piece 901 to the end 903c of the trim piece 903 (see FIG. 13) along the sewing line LN94. The sewing line LN95 extends in a direction intersecting a direction in which each of the sewing lines LN93, LN94 extends. Hence, the trim pieces 901, 903 and the resin plate member 912 are required to be rotated in the sewing.

In contrast, as illustrated in FIG. 6A, concerning the vehicle rear seat 1 according to the embodiment, simple sewing along two sewing lines (lines) LN20 and LN21 extending parallel to each other allows the trim 10 and the resin plate member 12 to join each other. In other words, as described above, the trim 10 is formed of a single continuous member, and has the bottom part 10a and the left side part 10b being continuous to each other. This eliminates the need for the sewing along the sewing line LN95 like the sewing for the resin plate member 912 illustrated in FIG. 6B. In the embodiment, the combination of sewing of the respective seam allowances of the bottom part 10a and the rear side part 10c together and sewing of the respective seam allowances of the bottom part 10a and the front side part 10d together along the two sewing the sewing lines LN20, LN21 completes the joining of the trim 10 and the resin plate member 12. Consequently, the embodiment enables joining of the trim 10 and the resin plate member 12 by repetitive sewing in the same direction without the need to rotate the trim 10 and the resin plate member 12 in the sewing.

### 5. Advantageous effects

In the vehicle rear seat 1 according to the embodiment, the trim 10 defining the inner bottom surface and the inner side surface of the belt buckle container 2b is formed of a single continuous member instead of a plurality of trim pieces sewing together like the trim pieces in the prior art. In the trim 10, the bottom part 10a is continuous to the side parts 10b to 10d, 10e1, and 10e2. This reduces a work related to the sewing owing to the continuous parts.

Concerning the vehicle rear seat 1 according to the embodiment, the single continuous member is three-dimensionally sewn to form the trim 10 having a three-dimensional shape. This configuration achieves a smaller number of steps to manage members at manufacturing the seat than the number of steps in the prior art in which the trim is formed of the plurality of trim pieces 901 to 903 three-dimensionally sewn. The configuration thus achieves a reduction in the manufacturing cost.

Concerning the vehicle rear seat 1 according to the embodiment, the single member is three-dimensionally sewn to form the trim 10 having a three-dimensional shape. This configuration means a smaller dimensional difference at cutting or sewing of the member than the dimensional difference in the prior art requiring the three-dimensional sewing of the trim pieces 901 to 903. The configuration thus attains a higher appearance quality.

In the vehicle rear seat 1 according to the embodiment, the left side part 10b is continuous to the bottom part 10a to constitute the trim 10. This means that the trim 10 can be formed of the single member to have a three-dimensional shape by making the side parts 10b to 10d, 10e1, and 10e2 stand from the bottom part 10a on a boundary of the continuous portion of the parts (on the line LN1) and sewing along the sewing line LN5 and the sewing line LN17 meeting each other, along the sewing line LN12 and the sewing line LN16 meeting each other, and along the sewing line LN7 and the sewing line LN18 meeting each other. In this manner, the trim 10 having the three-dimensional shape is constituted by the single member. This configuration hence attains a higher appearance quality while avoiding an increase in the manufacturing cost.

In the vehicle rear seat 1 according to the embodiment, the seam allowance 10e3 of the rear right side part 10e1 and the seam allowance 10e4 of the front right side part 10e2 are sewn together along the sewing lines LN12 and LN16 to thereby allow the side parts 10b to 10d, 10e1, and 10e2 to have an annular shape as a whole. The configuration allows the trim 10 to define an entire inner surface of the belt buckle container 2b. That is to say, the single member is three-dimensionally sewn to form the trim 10 having the three-dimensional shape and defining an entirety of the inner bottom surface and the inner side surface of the belt buckle container 2b.

In the vehicle rear seat 1 according to the embodiment, a sewn portion (seam S4) of the rear right side part 10e1 and the front right side part 10e2 is located at the central position of the right side part 10e (between adjacent corners) in the vehicular width direction. This increases the stiffness of the right side part 10e and is advantageous to attain a higher appearance quality.

In the vehicle rear seat 1 according to the embodiment, a right end of the bottom part 10a and a lower end of the right side part 10e are not sewn together to define the belt insertion opening 2d therebetween to allow the belt to be inserted therethrough. The unsewn portions result in defining the belt insertion opening 2d while increasing the workability without providing another opening in any of the side parts 10b to 10d and the bottom part 10a, or other part.

In the vehicle rear seat 1 according to the embodiment, the respective end sections (folded-back sections 10a2, 10e7, and 10e8) of the bottom part 10a and the right side part 10e constituting an edge defining the belt insertion opening 2d are folded back and sewn at overlapping portions respectively in the parts. The configuration achieves higher stiffness at the edge defining the belt insertion opening 2d, and thus avoids an undesirable opening state of the opening and reliably prevents the buckle from excessively falling or sinking.

In the vehicle rear seat 1 according to the embodiment, the bottom part 10a of the trim 10 and the resin plate member (reinforcement plate member) 12 are sewn together along the two straight lines extending parallel to each other, that is, are sewn along the sewing lines LN20, LN21. The configuration hence achieves ensured high workability without the need to change a sewing direction at sewing of the bottom part 10a and the resin plate member 12 together. This results in preventing an increase in the manufacturing cost.

Concerning the vehicle rear seat 1 according to the embodiment, the bottom part 10a and the rear side part 10c are sewn together in an overlapping state at the sewing along the sewing line LN20, and the bottom part 10a and the front side part 10d are sewn together in an overlapping state at the sewing along the sewing line LN21 (see FIG. 3). This enables firm sewing of the bottom part 10a and the resin plate member 12 together, and ensures high workability.

Conclusively, the vehicle rear seat 1 according to the embodiment includes the belt buckle container (recess) 2b having the inner bottom surface and the inner side surface defined by the trim 10, and further avoids an increase in the manufacturing cost and attains a superior appearance quality.

### First Modification

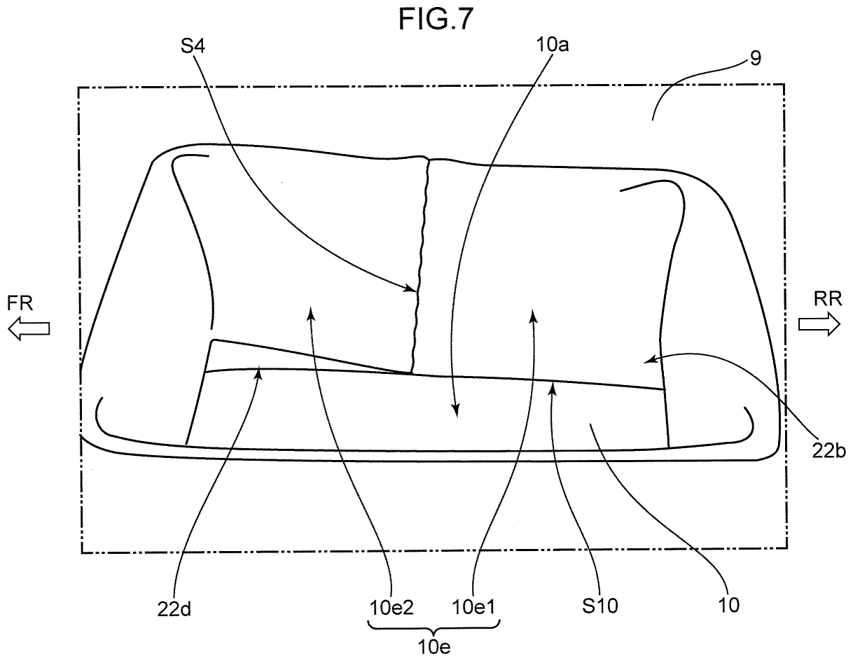

A configuration of a vehicle rear seat according to a first modification will be described with reference to FIG. 7. FIG. 7 illustrates excerption of a right side part 10e of a trim 10 and a periphery therearound at a belt buckle container 22b as a difference from the embodiment. The vehicle rear seat according to the present modification has the same configuration as the configuration in the embodiment concerning each component or part for which description will be omitted.

As illustrated in FIG. 7, the vehicle rear seat according to the modification includes the belt buckle container 22b having an inner surface defined by the trim 10. The trim 10 is formed of a single continuous member three-dimensionally sewn in the same manner as the trim 10 in the embodiment. In the modification, a lower end of a rear right side part 10e1 and a portion of a right end of a bottom part 10a are sewn together (along a seam S10).

In contrast, a lower end of a front right side part 10e2 and another portion of the right end of the bottom part 10a are not sewn together at a forward position from a seam S4 of the rear right side part 10e1 and the from right side part 10e2 in a vehicular front-rear direction to define a belt insertion opening 22d between the parts. In other words, the belt insertion opening 22d has a smaller dimension in a vehicular width direction in the modification than a dimension of the opening in the embodiment. Further, the rear right side part 10e1 and the front right side part 10e2 are sewn together along the seam S4, and the lower end of the rear right side part 10e1 and the portion of the right end of the bottom part 10a are sewn together along the seam S10. The modification is hence superior to ensure high stiffness of the right side part 10e.

The modification is the same as the embodiment except the configuration of the belt insertion opening 22d, and thus exerts the same effect as the effect of the embodiment.

### Second Modification

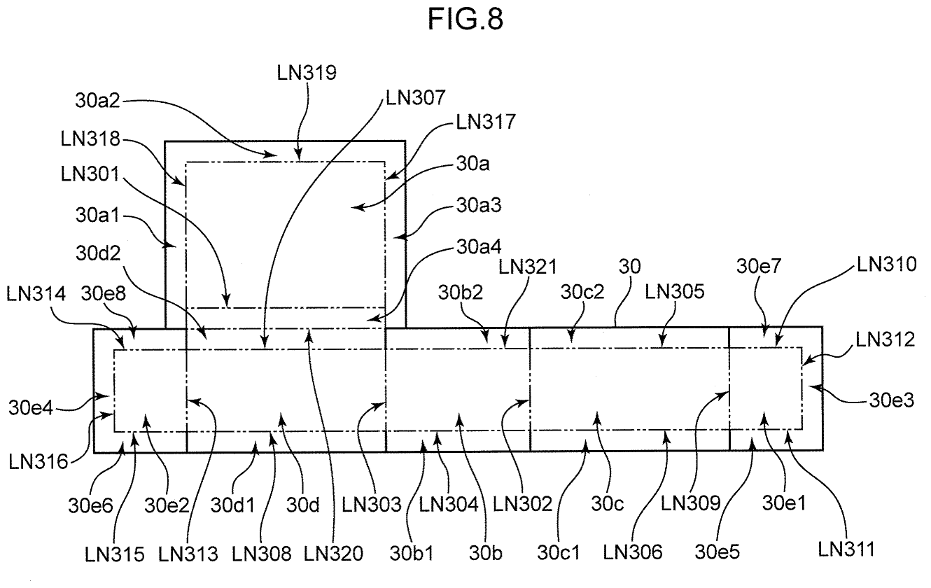

A configuration of a vehicle rear seat according to a second modification will be described with reference to FIG. 8. FIG. 8 illustrates a trim 30 yet to be three-dimensionally sewn without illustration of other configuration. The vehicle rear seat according to the present modification has the same configuration as the configuration in the embodiment concerning each component or part for which description will be omitted.

As illustrated in FIG. 8, the trim 30 is formed of a single member, and has parts 30a to 30d, 30e1, and 30e2 being continuous and each having a rectangular shape. The side parts 30b to 30d, 30e1, and 30e2 are continuous to have a long strip shape as a whole. The bottom part 30a is continuous to the front side part 30d across seam allowances 30a4, 30d2 and protrudes in a direction perpendicularly intersecting a longitudinal direction of the side parts 30b to 30d, 30e1, and 30e2.

The trim 30 has sections to be folded-back, i.e., folded-back sections 30a1, 30e7, and 30e8, and seam allowances 30a2 to 30a4, 30b1, 30b2, 30c1, 30c2, and 30e3 to 30e6, the sections and seam allowances serving as associated ends of the parts 30a to 30d, 30e1, and 30e2. In the modification, the bottom part 30a and the front side part 30d are continuous to each other across the two seam allowances 30a4, 30d2.

The trim 30 in the modification is bent on a line LN320 and sewn along sewing lines LN301, LN307 meeting each other to make a “valley fold” or inward bend between the bottom part 30a and the front side part 30d.

In this modification, the folded-back sections 30a1, 30e7, and 30e8, and the seam allowances 30a2 to 30a4, 30b1, 30b2, 30c1, 30c2, and 30e3 to 30e6 are continuous to the parts 30a to 30d, 30e1, and 30e2 across associated lines LN301, LN304 to LN308, LN310 to LN312, LN314 to LN319, and LN321. The folded-back sections 30a1, 30e7, and 30e8 are folded back respectively on the creases LN318, LN310, and LN314, and sewn at overlapping portions respectively in the same manner as in the embodiment.

In three-dimensionally sewing the trim 30 illustrated in FIG. 8, the trim 30 is bent on the lines LN302, LN303, LN309, LN313, and LN320, and facing ends are sewn together. Specifically, the trim 30 is sewn along the sewing line LN301 and the sewing line LN307 meeting each other. The trim 30 is sewn along the sewing line LN321 and the sewing line LN317 meeting each other, and sewn along the sewing line LN305 and the sewing line LN319 meeting each other. The trim 30 is further sewn along the sewing line LN312 and the sewing line LN316 meeting each other. Besides, the trim 30 is sewn to ends of a sitting base trim 9 (not shown) along the sewing lines LN304, LN306, LN308, LN311, and LN315.

Here, the trim 30 is not sewn along the creases LN318, LN310, and LN314 meeting one another, and the folded-back sections 30a1, 30e7, 30e8 are folded back respectively on the creases LN318, LN310, and LN314 and sewn at overlapping portions respectively.

Although the modification differs from the embodiment in that the bottom part 30a is continuous to the front side part 30d, and the two seam allowances 30a4, 30d2 are provided between the bottom part 30a and the front side part 30d, it exerts the same effects as those of the embodiment. Moreover, the modification provides a sewn portion of the bottom part 30a and the front side part 30d, and thus achieves higher stiffness.

### Third Modification

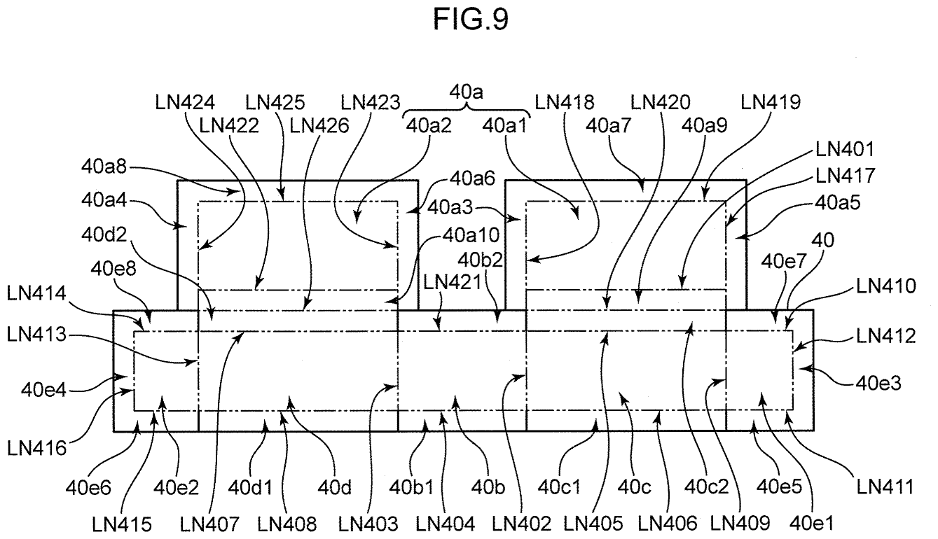

A configuration of a vehicle rear seat according to a third modification will be described with reference to FIG. 9. FIG. 9 illustrates a trim 40 yet to be three-dimensionally sewn without illustration of other configuration. The vehicle rear seat according to the present modification has the same configuration as the configuration in the embodiment concerning each component or part for which description will be omitted.

As illustrated in FIG. 9, the trim 40 is formed of a single member, and has parts 40a1, 40a2, 40b to 40d, 40e1, and 40e2 being continuous and each having a rectangular shape. The side parts 40b to 40d, 40e1, and 40e2 are continuous to have a long strip shape as a whole. The rear bottom part 40a1 is continuous to the rear side part 40c across seam allowances 40a9, 40c2 and protrudes in a direction perpendicularly intersecting a longitudinal direction of the side parts 40b to 40d, 40e1, and 40e2. The front bottom part 40a2 is continuous to the front side part 40d across seam allowances 40a10, 40d2 and protrudes in a direction perpendicularly intersecting the longitudinal direction of the side parts 40b to 40d, 40e1, and 40e2.

In the modification, the rear bottom part 40a1 and the front bottom part 40a2 constitute the bottom part 40a. Specifically, the seam allowance 40a7 of the rear bottom part 40a1 and the seam allowance 40a8 of the front bottom part 40a2 are sewn together along the sewing lines LN419 and LN425 meeting each other to constitute the bottom part 40a.

The trim 40 has sections to be folded-back, i.e., folded-back sections 40a4, 40a5, 40e7, and 40e8, and seam allowances 40a3, 40a6 to 40a10, 40b1, 40b2, 40c1, 40c2, 40d1, 40d2, and 40e3 to 40e6, the sections and seam allowances serving as associated ends of the parts 40a1, 40a2, 40b to 40d, 40e1, and 40e2.

The trim 40 in the modification is bent on a line LN420 and sewn along the sewing line LN401 and the sewing line LN405 meeting each other to make a valley fold between the rear bottom part 40a1 and the rear side part 40c, and bent on a line LN426 and sewn along the sewing line LN407 and the sewing line LN422 meeting each other to make a valley fold between the front bottom part 40a2 and the front side part 40d.

In this modification, the folded-back sections 40a4, 40a5, 40e7, and 40e8 and the seam allowances 40a3, 40a6 to 40a10, 40b1, 40b2, 40c1, 40c2, 40d1, 40d2, and 40e3 to 40e6 are continuous to the parts 40a1, 40a2, 40b to 40d, 40e1, and 40e2 across associated lines LN401, LN404 to LN408, LN410 to LN412, LN414 to LN419, and LN421 to LN425. The folded-back sections 40a4, 40a5, 40e7, and 40e8 are folded back respectively on the creases LN424, LN417, LN410, and LN414, and sewn at overlapping portions respectively in the same manner as in the embodiment.

In three-dimensionally sewing the trim 40 illustrated in FIG. 9, the trim is bent on the sewing line LN420 and sewn along the sewing line LN401 and the sewing line LN405 meeting each other to make a valley fold, and bent on sewing line LN426 and sewn along the sewing line LN407 and the sewing line LN422 meeting each other to make a valley fold. Further, the trim 40 is sewn along the sewing line LN421, and the sewing lines LN418, LN423 meeting one another, and sewn along the sewing line LN419 and the sewing line LN425 meeting each other. The folded-back sections 40a4, 40a5, 40e7, and 40e8 are folded back to be sewn respectively in association with the front bottom part 40a2, the rear bottom part 40a1, the rear right side part 40e1, and the front right side part 40e2 along the sewing line LN412 and the sewing line LN416 meeting each other. Besides, the trim 40 is sewn to ends of a sitting base trim 9 (not shown) along the sewing lines LN404, LN406, LN408, LN411, and LN415.

The bottom part 40a is not sewn to the rear right side part 40e1 and not sewn to the front right side part 40e2 to define a belt insertion opening between the bottom part and each of the right side parts.

Although the modification differs from the embodiment in that the bottom part 40a includes the rear bottom part 40a1 and the front bottom part 40a2, it exerts the same effects as those of the embodiment. In addition, the modification makes a valley fold between the rear bottom part 40a1 and the rear side part 40c by bending the seam allowances 40a9, 40c2 and sewing along the sewing lines LN405 and LN401 meeting each other, and a valley fold between the front bottom part 40a2 and the front side part 40d by bending the seam allowances 40a10, 40d2 and sewing along the sewing lines LN407 and LN422 meeting each other. The modification consequently achieves higher stiffness.

### Fourth Modification

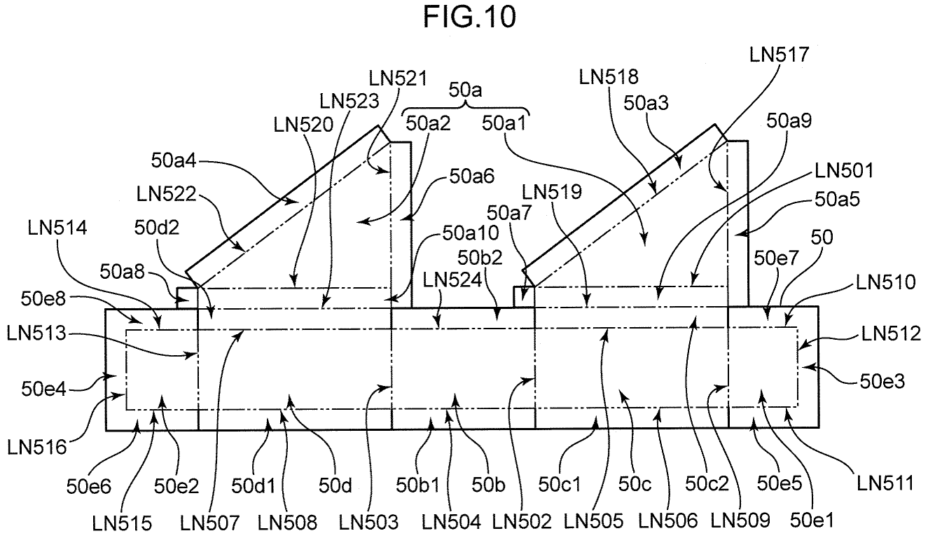

A configuration of a vehicle rear seat according to a fourth modification will be described with reference to FIG. 10. FIG. 10 illustrates a trim 50 yet to be three-dimensionally sewn without illustration of other configuration. The vehicle rear seat according to the present modification has the same configuration as the configuration in the embodiment concerning each component or part for which description will be omitted.

As illustrated in FIG. 10, the trim 50 is formed of a single member, and has parts 50a1 and 50a2 each having a triangular shape, and parts 50b to 50d, 50e1, and 50e2 being continuous and each having a rectangular shape. The side parts 50b to 50d, 50e1, and 50e2 are continuous to have a long strip shape as a whole. The rear bottom part 50a1 has the triangular shape, is continuous to the rear side part 50c across two seam allowances 50a9, 50c2, and protrudes in a direction perpendicularly intersecting a longitudinal direction of the side parts 50b to 50d, 50e1, and 50e2. The front bottom part 50a2 has the triangular shape, is continuous to the front side part 50d across two seam allowances 50a10, 50d2, and protrudes in a direction perpendicularly intersecting the longitudinal direction of the side parts 50b to 50d, 50e1, and 50e2.

In the modification, the rear bottom part 50a1 and the front bottom part 50a2 constitute the bottom part 50a. Specifically, a seam allowance 50a3 of the rear bottom part 50a1 and a seam allowance 50a4 of the front bottom part 50a2 are bent and sewn along a sewing line LN518 and a sewing line LN522 meeting each other to constitute the bottom part 50a.

The trim 50 has sections to be folded-back, i.e., folded-back sections 50a5, 50e7, and 50e8, and seam allowances 50a3, 50a4, 50a6 to 50a10, 50b1, 50b2, 50c1, 50c2, 50d1, 50d2, and 50e3 to 50e6, the sections and seam allowances serving as associated ends of the parts 50a1, 50a2, 50b to 50e, 50e1, and 50e2.

The trim 50 in the modification is bent on a line LN519 and sewn along the sewing line LN505 and the sewing line LN501 meeting each other to make a valley fold between the rear bottom part 50a1 and the rear side part 50c, and bent on a line LN523 and sewn along the sewing line LN507 and the sewing line LN520 meeting each other to make a valley fold between the front bottom part 50a2 and the front side part 50d. The modification consequently ensures higher stiffness with the sewn portions.

In this modification, the folded-back sections 50a5, 50e7, and the 50e8, and the seam allowances 50a3, 50a4, 50a6 to 50a10, 50b1, 50b2, 50c1, 50c2, 50d1, 50d2, and 50e3 to 50e6 are continuous to the parts 50a1, 50a2, 50b to 50d, 50e1, and 50e2 across associated lines LN501, LN504 to LN508, LN510 to LN512, LN514 to LN518, LN520 to LN522, and LN524. The folded-back sections 50a5, 50e7, and 50e8 are folded back respectively on the creases LN517, LN510, and LN514, and sewn in the same manner as in the embodiment.

In three-dimensionally sewing the trim 50 illustrated in FIG. 10, the trim 50 is bent on the lines LN502, LN503, LN509, LN513, LN519, and LN523, and facing ends are sewn together. Specifically, the trim 50 is bent on the line LN519 and sewn along the sewing line 501 and the sewing line LN505 meeting each other to make a valley fold, and bent on the line LN523 and sewn along the sewing line LN507 and the sewing line LN520 meeting each other to make a valley fold. The folded-back sections 50a5, 50e7, and 50e8 are folded back to be sewn respectively in association with the rear bottom part 50a1, the rear right side part 50e1, and the front right side part 50e2. The seam allowances 50a3, 50a4, 50a7, 50a8, 50b1, 50b2, 50c1, 50d1, 50e3 to 50e6 are bent and sewn along the associated sewing lines LN501, LN504 to LN508, LN511, LN512, LN515, LN516, LN518, LN520 to LN522, LN524.

The bottom part 50a is not sewn to the rear right side part 50e1 and to the front right side part 50e2 to define a belt insertion opening between the bottom part and each of the right side parts.

Although the modification differs from the embodiment in that the bottom part 50a includes the rear bottom part 50a1 and the front bottom part 50a2 each having the triangular shape, it exerts the same effects as those of the embodiment. Furthermore, the modification in which each of the rear bottom part 50a1 and the front bottom part 50a2 has the triangular shape achieves fewer sewn portions and a smaller number of manufacturing steps than the sewn portions and the number of manufacturing steps in the third modification described above. Moreover, the modification in which the sewn portion of the rear bottom part 50a1 and the front bottom part 50a2 extends in an oblique direction intersecting both the vehicular front-rear direction and the vehicular W8885 width direction achieves high stiffness in both the front-rear direction and the vehicular width direction.

### Fifth Modification

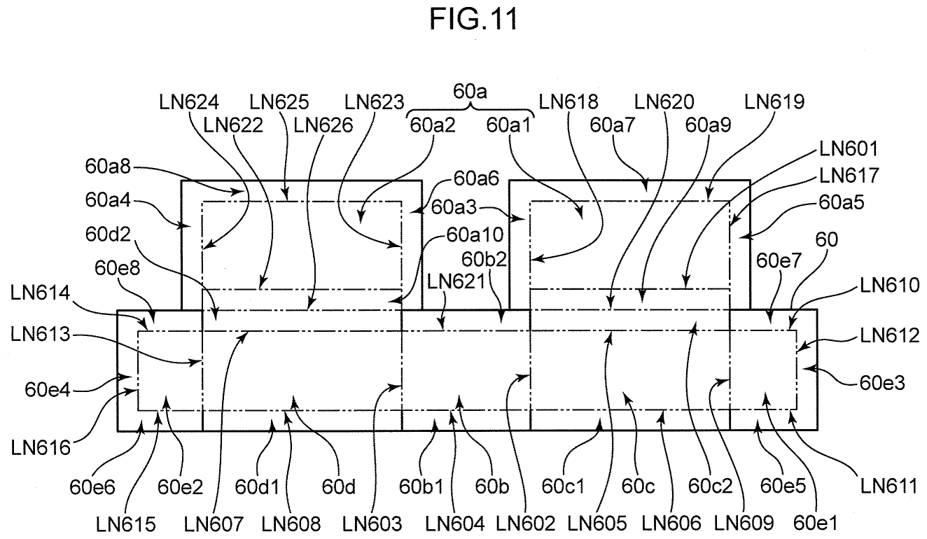

A configuration of a vehicle rear seat according to a fifth modification will be described with reference to FIG. 11. FIG. 11 illustrates a trim 60 yet to be three-dimensionally sewn without illustration of other configuration. The vehicle rear seat according to the present modification has the same configuration as the configuration in the embodiment concerning each component or part for which description will be omitted.

As illustrated in FIG. 11, the trim 60 is formed of a single member, and has parts 60a1, 60a2, 60b to 60d, 60e1, and 60e2 being continuous and each having a rectangular shape. The side parts 60b to 60d, 60e1, and 60e2 are continuous to have a long strip shape as a whole. The front bottom part 60a1 is continuous to the front side part 60c across seam allowances 60a9, 60c2 and protrudes in a direction perpendicularly intersecting the longitudinal direction of the side parts 60b to 60d, 60e1, and 60e2. The rear bottom part 60a2 is continuous to the rear side part 60d across seam allowances 60a10, 60d2 and protrudes in a direction perpendicularly intersecting the longitudinal direction of the side parts 60b to 60d, 60e1, and 60e2.

In the modification, the front bottom part 60a1 and the rear bottom part 60a2 constitute the bottom part 60a like the front and rear bottom parts 40a1, 40a2 in the third modification. Specifically, the seam allowance 60a7 of the front bottom part 60a1 and the seam allowance 60a8 of the rear bottom part 60a2 are sewn together along sewing lines LN619 and LN625 meeting each other to constitute the bottom part 60a.

The trim 60 has sections to be folded-back, i.e., folded-back sections 60a3, 60a6, and 60b2, and seam allowances 60a4, 60a5, 60a7 to 60a10, 60b1, 60c1, 60c2, 60d1, 60d2, and 60e3 to 60e8, the sections and seam allowances serving as associated ends of the parts 60a1, 60a2, 60b to 60d, 60e1, and 60e2.

The trim 60 in the modification is bent on a line LN620 and sewn along the sewing line LN601 and the sewing line LN605 meeting each other to make a valley fold between the front bottom part 60a1 and the front side part 60c, and bent on a line LN626 and sewn along the sewing line LN622 and the sewing line LN607 meeting each other to make a valley fold between the rear bottom part 60a2 and the rear side part 60d. The modification consequently ensures higher stiffness with the sewn portions.

In this modification, the folded-back sections 60a3, 60a6, and 60b2, and the seam allowances 60a4, 60a5, 60a7 to 60a10, 60b1, 60c1, 60c2, 60d1, 60d2, and 60e3 to 60e8 are continuous to the parts 60a1, 60a2, 60b to 60d, 60e1, and 60e2 across associated lines LN601, LN604 to LN608, LN610 to LN618, and LN621 to LN625. The folded-back sections 60a3, 60a6, 60b2 are folded back respectively on the creases LN618, LN623, and LN621, and sewn in the same manner as in the embodiment.

In three-dimensionally sewing the trim 60 illustrated in FIG. 11, the trim 60 is bent on the lines LN602, LN603, LN609, LN613, LN620, and LN626, and facing ends are sewn together. Specifically, the trim 60 is sewn along the sewing lines LN601 and LN605 meeting each other, and along the sewing lines LN622 and LN607 meeting each other. The folded-back sections 60b2, 60a3, and 60a6 are folded back to be sewn respectively in association with the right side part 60b, the front bottom part 60a1, and the rear bottom part 60a2. Further, the trim 60 is sewn along the sewing line LN610 and the sewing line LN617 meeting each other and sewn along the sewing line LN614 and the sewing line LN624 meeting each other, and further sewn along the sewing line LN612 and the sewing line LN616 meeting each other. Besides, the trim 60 is sewn to ends of a sitting base trim 9 (not shown) along the sewing lines LN604, LN606, LN608, LN611, and LN615.

In the modification, a lower portion of the right side part 60b is not sewn to the front bottom part 60a1 and to the rear bottom part 60a2 so as to define a belt insertion opening between the lower portion of the right side part and each of the front and rear bottom parts.

Although the modification differs from the third modification in the location of the belt insertion opening (where the crease LN621 meets each of the crease LN618 and the crease LN623), it exerts the same effects as those of the embodiment and the third modification.

### Sixth Modification

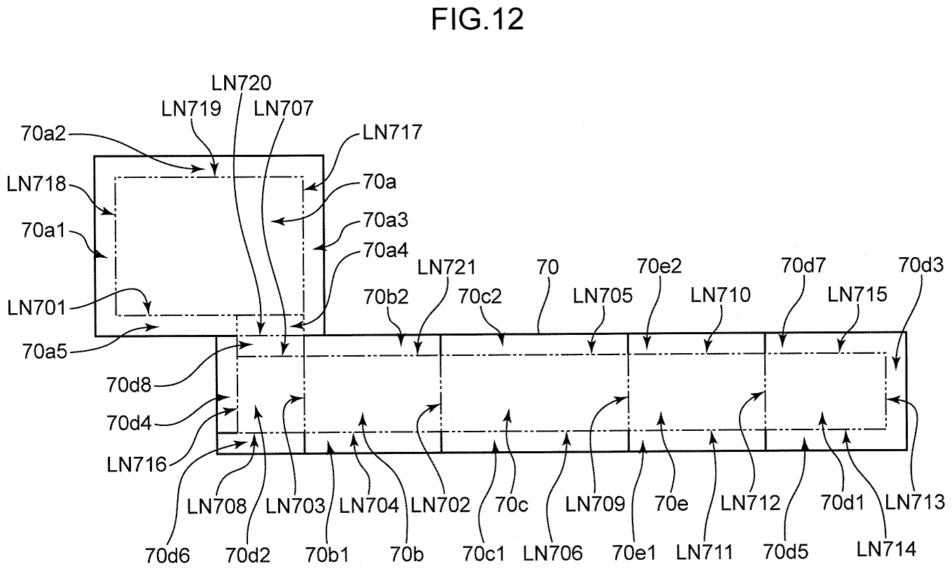

A configuration of a vehicle rear seat according to a sixth modification will be described with reference to FIG. 12. FIG. 12 illustrates a trim 70 yet to be three-dimensionally sewn without illustration of other configuration. The vehicle rear seat according to the present modification has the same configuration as the configuration in the embodiment concerning each component or part for which description will be omitted.

As illustrated in FIG. 12, the trim 70 is formed of a single member, and has parts 70a to 70c, 70d1, 70d2, and 70e being continuous and each having a rectangular shape. The side parts 70b, 70c, 70d1, 70d2, and 70e are continuous to have a long strip shape as a whole. The bottom part 70a is continuous to the right rear side part 70d2 across seam allowances 70a4, 70d8 and protrudes in a direction perpendicularly intersecting a longitudinal direction of the side parts 70b, 70c, 70d1, 70d2, and 70e.

The trim 70 has sections to be folded-back, i.e., folded-back sections 70a3 and 70b2, and seam allowances 70a1, 70a2, 70a4, 70a5, 70b1, 70c1, 70c2, 70d3 to 70d8, 70e1, and 70e2, the sections and seam allowances serving as associated ends of the parts 70a to 70c, 70d1, 70d2, and 70e. In the modification, the two seam allowances 70a4, 70d8 are provided between the bottom part 70a and the right rear side part 70d2.

Specifically, the trim 70 in the modification is bent on a line LN720 and sewn along a sewing line LN701 and a sewing line LN707 meeting each other to make a valley fold between the bottom part 70a and the right rear side part 70d2. The modification consequently ensures higher stiffness with the sewn portions.

In this modification, the folded-back sections 70a3 and 70b2, and the seam allowances 70a1, 70a2, 70a4, 70a5, 70b1, 70c1, 70c2, 70d3 to 70d8, 70e1, and 70e2 are continuous to the parts 70a to 70c, 70d1, 70d2, and 70e across associated sewing lines LN701, LN704 to LN708, LN710, LN711, LN713 to LN716, LN718, and LN719. The folded-back sections 70a3 and 70b2 are folded back respectively on creases LN717 and LN721, and sewn in the same manner as in the embodiment.

In three-dimensionally sewing the trim 70 illustrated in FIG. 12, the seam allowances 70b1, 70c2, 70d3, 70d4, 70d7, 70d8, and 70e2 are bent on the sewing lines LN701, LN705 to LN707, LN710, LN713, LN715, LN716, LN718, and LN719, and sewn along the sewing lines LN701, LN705 to LN707, LN710, LN713, LN715, LN716, LN718, and LN719. Besides, the trim 70 is sewn to ends of a sitting base trim 9 (not shown) along the sewing lines LN704, LN706, LN708, LN711, and LN714.

In the modification, the bottom part 70a and the right side part 70b are not sewn together to define a belt insertion opening between the parts.

Although the modification differs from the second modification in that the left rear side part 70d1 and the right rear side part 70d2 constitute the rear side part and that the bottom part 70a is continuous to the right rear side part 70d2, it exerts the same effects as those of the embodiment and the second modification. Moreover, the modification provides the sewn portion along the sewing line LN713 and the sewing line LN716 meeting each other in the rear side part achieves higher stiffness in the rear side part.

### Other Modifications

Although no material is particularly referred to for each of the trims 10, and 30 to 70 in the embodiment and the first to sixth modifications, various kinds of sheet-like materials having flexibility are adoptable. For instance, a sheet member made of natural leather, synthetic leather, or other material, or a fabric sheet member is adoptable.

Although each of the embodiment and the first to sixth modifications adopts the vehicle rear seat 1 as an example seat, the configuration of the present invention is applicable to other seat.

Although each of the embodiment and the first to sixth modifications adopts the belt buckle container 2b, 2c, 22b as an example recess, the present invention is applicable to, for example, a cup holder and a small container without limitation to the buckle container. It is not necessary to provide such a recess in a seat cushion. The recess may be provided in an armrest or in a seatback.

Each of the embodiment and the first to sixth modifications defines each of the belt buckle containers 2b, 2c to respectively accommodate belt buckles as an example recess. Hence, the recess is configured to have the associated one of the belt insertion openings 2d, 22d at the bottom of the recess. However, the present invention may not necessarily define such a recess at the bottom.

Although each of the embodiment and the first to sixth modifications adopts a recess (belt buckle container 2b, 2c) having a rectangular shape in a plan view as an example, the present invention may adopt a recess having a circular shape, an oval shape, or a polygonal shape in a plan view.

Although each of the embodiment and the first to sixth modifications joins the reinforcement plate member (resin plate member 12) to the back surface of the bottom part 10a, 30a, 40a, 50a, 60a, 70a of the trim 10, 30 to 70 (closer to the cushion pad), the present invention does not require the joining of the reinforcement plate member. A material for the reinforcement plate member is not limited to such a resin plate member, for example, made of polypropylene (PP), and any material having higher stiffness than the trim is adaptable. For instance, a metal plate member is adoptable. Further, although the reinforcement plate member (resin plate member 12) is joined along a sewing line (seam S5) which is different from the sewing line (seam S3) for the bottom part and the side part in each of the embodiment and the first to sixth modifications, the three parts of the bottom part, the side part, and the reinforcement plate member may be sewn together in an overlapping state through once sewing.

### Conclusion

A seat according to one aspect of the present invention is a seat including a recess having an inner bottom surface and an inner side surface defined by a trim. The trim is formed of a single member three-dimensionally sewn, and has: a bottom part that defines the inner bottom surface of the recess; and a side part that defines the inner side surface of the recess, the bottom part and the side part being continuous to each other.

In the seat in the aspect, the trim defining the inner bottom surface and the inner side surface of the recess is formed of a single continuous member three-dimensionally sewn. This configuration achieves a reduction in the work related to the sewing in comparison with a configuration of the prior art in which trim pieces are three-dimensionally sewn.

The seat in the aspect in which the trim is formed of the single continuous member achieves a smaller number of steps to manage members at manufacturing the seat than the number of steps in the prior art in which the trim is formed of a plurality of members. The configuration thus achieves a reduction in the manufacturing cost.

Concerning the seat in the aspect, the single continuous member is three-dimensionally sewn to form the trim having a three-dimensional shape. This configuration means a smaller dimensional difference at cutting or sewing of the member than the dimensional difference in a configuration adopting a plurality of members. The configuration thus attains a higher appearance quality.

In the seat in the above aspect, the side part may have a long strip shape. The bottom part may be continuous to a portion of the side part on a long side of the side part in a longitudinal direction thereof, and protrude from the continuous portion in a direction intersecting the longitudinal direction. At least a portion of an end of the bottom part and a portion of an end of the side part may be sewn together except the continuous portion.

In the seat in the above aspect, the bottom part is continuous to a portion of the side part on the long side of the side part in the longitudinal direction thereof to constitute the trim. This means that the trim can be formed of the single member to have the three-dimensional shape by making the side part stand from the bottom part on a boundary of the continuous portion and sewing at least respective portions of the ends together. This configuration hence attains a higher appearance quality while preventing an increase in the manufacturing cost.

In the seat according to the aspect, the side part may have facing ends sewn together in the longitudinal direction.

In the seat in this aspect, the facing ends of the side part are sewn together to thereby allow the side part to have an annular shape and define an entire inner side surface of the recess. In other words, the single member is three-dimensionally sewn to attain the trim defining an entirety of the inner bottom surface and the inner side surface of the recess.

In the seat according to the aspect, the bottom part may have a rectangular shape in a plan view, and the opposite ends of the side part sewn together may be located between adjacent corners of the bottom part.

In the seat in this aspect, the facing ends of the side part sewn together is located between the adjacent corners of the bottom part. This increases the stiffness of the side part and is advantageous to attain a higher appearance quality.

In the seat according to the aspect, the seat may be a vehicle seat. The recess may serve as a belt buckle container configured to accommodate a belt buckle therein. The trim may have an opening defined between the location of the facing ends of the side part sewn together and one of the corners of the bottom part so as to open between another portion of the end of the side part and another portion of the end of the bottom part which are not sewn together. The opening may allow a belt to be inserted therethrough and connected to the belt buckle.

In the seat in this aspect, a certain portion of an end of the bottom part and a certain portion of an end of the side part are not sewn together to define an opening therebetween to allow the belt to be inserted through the opening. The unsewn portions result in defining the opening or belt insertion opening while increasing the workability without providing another opening in any of the side part and the bottom part, or other part.

In the seat according to the aspect, at the opening of the trim, the side part may be folded back in a short direction of the side part to have a folded-back section and the bottom part is folded back in a direction perpendicularly intersecting a direction in which an edge side of the bottom part extends to have a folded-back section, the folded-back sections being sewn at overlapping portions (made owing to the folding-back) respectively in the side part and the bottom part.

In the seat in this aspect, the respective end sections of the bottom part and the side part constituting the edge defining the opening are folded back and sewn at the overlapping portions made owing to the folding-back. This configuration achieves higher stiffness at the edge defining the opening, and thus avoids an undesirable opening state of the opening and reliably prevents the buckle from excessively falling or sinking.

The seat in the aspect may further include a reinforcement plate member joined to a back surface of the bottom part and made of material having higher stiffness than the trim. The trim and the reinforcement plate member may be joined to each other through sewing along two lines extending parallel to each other in a plan view.

In the seat in this aspect, the bottom part of the trim and the reinforcement plate member are sewn together along two lines (straight or curvy lines) extending parallel to each other, and are joined to each other through the sewing. The configuration hence achieves ensured high workability without the need to change a sewing direction at sewing of the bottom part and the reinforcement plate member together. This results in preventing an increase in the manufacturing cost.

In the seat according to the aspect, a portion of the bottom part of the trim, a portion of the side part of the trim, and the reinforcement plate member may be joined together in a state where the portions overlap one another through the sewing along the two lines.

In the seat in this aspect, the bottom part and the side part are joined to each other in the same manner as the joining of the bottom part and the reinforcement plate member. This enables firm joining or sewing of the bottom part and the reinforcement plate member together, and ensures high workability.

Conclusively, a seat according to the aspect includes a recess having an inner bottom surface and an inner side surface defined by a trim, and further avoids an increase in a manufacturing cost and attains a superior appearance quality.

1. A seat, comprising:
a recess having an inner bottom surface and an inner side surface defined by a trim, wherein
the trim is formed of a single member three-dimensionally sewn, and has:
a bottom part that defines the inner bottom surface of the recess; and
a side part that defines the inner side surface of the recess,
the bottom part and the side part being continuous to each other.

2. The seat according to claim 1, wherein the side part has a long strip shape,
the bottom part is continuous to a portion of the side part on a long side of the side part in a longitudinal direction thereof, and protrudes from the continuous portion in a direction intersecting the longitudinal direction, and
at least a portion of an end of the bottom part and a portion of an end of the side part are sewn together except the continuous portion.

3. The seat according to claim 2, wherein the side part has facing ends sewn together in the longitudinal direction.

4. The seat according to claim 3, wherein the bottom part has a rectangular shape in a plan view, and
the facing ends of the side part sewn together are located between adjacent corners of the bottom part.

5. The seat according to claim 4, wherein the seat is a vehicle seat,
the recess serves as a belt buckle container configured to accommodate a belt buckle therein, and
the trim has an opening, defined between the location of the facing ends of the side part sewn together and one of the corners of the bottom part, where the end of the side part and the end of the bottom part are not sewn together,
the opening allowing a belt to be inserted therethrough and connected to the belt buckle.

6. The seat according to claim 5, wherein, at the opening of the trim, the side part is folded back in a short direction of the side part to have a folded-back section and the bottom part is folded back in a direction perpendicularly intersecting a direction in which an edge side of the bottom part extends to have a folded-back section, the folded-back sections being sewn at overlapping portions respectively in the side part and the bottom part.

7. The seat according to claim 1, further comprising a reinforcement plate member joined to a back surface of the bottom part and made of material having higher stiffness than the trim, wherein
the trim and the reinforcement plate member are joined to each other through sewing along two lines extending parallel to each other in a plan view.

8. The seat according to claim 7, wherein a portion of the bottom part of the trim, a portion of the side part of the trim, and the reinforcement plate member are joined together in a state where the portions overlap one another through the sewing along the two lines.
